(19) United States
(12) Patent Application Publication
(10) Pub. No.: US 2013/0200556 A1
(43) Pub. Date: Aug. 8, 2013

(54) METHOD FOR PRODUCING CEMENTED CARBIDE PRODUCTS

(71) Applicant: Per Jonsson, Fors (SE)

(72) Inventor: Per Jonsson, Fors (SE)

(73) Assignee: SECO TOOLS AB, FAGERSTA (SE)

(21) Appl. No.: 13/699,326

(22) PCT Filed: May 25, 2011
(86) PCT No.: PCT/SE2011/000091

§ 371 Date: Dec. 7, 2012

(30) Foreign Application Priority Data
May 26, 2010 (SE) 1050524-6

(51) Int. Cl. B29B 11/08

(52) U.S. Cl. CPC B29B 11/08
USPC 264/645

(57) ABSTRACT

The present invention relates to a method for the production of cemented carbide based hard metal parts comprising hard constituents in a binder phase by using powder injection moulding or extrusion of a mixture of hard constituents and binder phase in organic binders having a melting point: mixing. The method includes the steps of mixing the powders of hard constituents and binder phase to form a mixture and heating the mixture of hard constituents and binder phase to a temperature. When the temperature of the mixture of hard constituents and binder phase is above the melting point of the organic binders, the organic binders are added in melted form, making sure that the temperature does not fall below the melting point of the organic binders. The parts are formed by powder injection moulding or extrusion. The organic binders are removed from the obtained parts by a debinding step and the parts are sintered.

The present invention relates to a method for the production of tungsten carbide based hard metal tools or components using the powder injection moulding or extrusion method.

Hard metals based on tungsten carbide are composites consisting of small (μm-scale) grains of at least one hard phase in a binder phase. These materials always contain the hard phase tungsten carbide (WC). In addition, other metal carbides with the general composition (Ti, Nb, Ta, W)C may also be included, as well as metal carbonitrides, e.g., Ti(C, N). The binder phase usually consists of cobalt (Co). Other binder phase compositions may also be used, e.g., combinations of Co, Ni, and Fe, or Ni and Fe.

Industrial production of tungsten carbide based hard metals often includes blending of given proportions of powders of raw materials and additives in the wet state using a milling liquid. This liquid is often an alcohol, e.g. ethanol or water, or a mixture thereof. The mixture is then milled into a homogeneous slurry. The wet milling operation is made with the purpose of deagglomerating and mixing the raw materials intimately. Individual raw material grains are also disintegrated to some extent. The obtained slurry is then dried and granulated, e.g. by means of a spray dryer. The granulate thus obtained may then be used in uniaxial pressing of green bodies or for extrusion or injection moulding.

Injection moulding is common in the plastics industry, where material containing thermoplastics or thermosetting polymers are heated and forced into a mould with the desired shape. The method is often referred to as Powder Injection Moulding (PIM) when used in powder technology. The method is preferably used for parts with complex geometry.

In powder injection moulding of tungsten carbide based hard metal parts, four consecutive steps are applied:

1. Mixing of the granulated cemented carbide powder with a binder system. The binder system acts as a carrier for the powder and constituents 25-60 volume % of the resulting material, often referred to as the feedstock. The exact concentration is dependent on the desired process properties during moulding. The mixing is made by adding all the constituents into a mixer heated to a temperature above the melting temperature of the organic binders. The resulting feedstock is obtained as pellets of approximate size 4×4 mm.

2. Injection moulding is performed using the mixed feedstock. The material is heated to 100-240° C. and then forced into a cavity with the desired shape. The thus obtained part is cooled and then removed from the cavity.

3. Removing the binder from the obtained part. The removal can be obtained by extraction of the parts in a suitable solvent and/or by heating in a furnace with a suitable atmosphere. This step is often referred to as the debinding step.

4. Sintering of the parts. Common sintering procedures for cemented carbides are applied.

Extrusion of the feedstock comprises steps 1, 3 and 4 above. Instead of forcing the feedstock into a cavity of the desired shape, the feedstock is continuously forced through a die with the desired cross section.

The solids loading, φ, of the feedstock is the volumetric amount of hard constituents, compared to the organic constituents. φ can be calculated using the following equation:

$$φ = \frac{{ρ}_{f} - {ρ}_{v}}{{ρ}_{s} - {ρ}_{v}}$$

where ρₛ is the density of the cemented carbide as sintered, ρᵥ is the mean density of the organic constituents and ρ_{f} is the density of the feedstock, measured with the helium pycnometer.

When mixing the cemented carbide powder with the organic binders, it is a common problem that a part of the organic binders does not spread properly in the feedstock. Instead, a small part of the organic binders forms particles, considerably larger than the grain size of the hard constituents, i.e. in the range of 10-30 μm. During the debinding of the green body, these particles will be removed, leaving pores in the structure. A common way to remove these pores is to use sintering with applied hydrostatic pressure of Ar, i.e., sinter-HIP:ing. When using sinter-HIP:ing, the pores will be filled with the metallic binder phase if the pores have no physical connection with the applied pressure. Pores close to the surface of the green body will instead collapse to form surface pores, as will pores located directly in the surface of the green body. The pores in the surface will severely decrease the macroscopic mechanical strength of the sintered material. The metallic binder filled former pores in the bulk of the material will decrease the mechanical strength of the sintered material as well. Another common problem in case of the particles of organic binders being large, i.e. in the range of 20-30 μm, these particles will pyrolyse with a too fast development of gases during the debinding step, forming blisters in the material structure.

It is an object of the present invention to solve these problems.

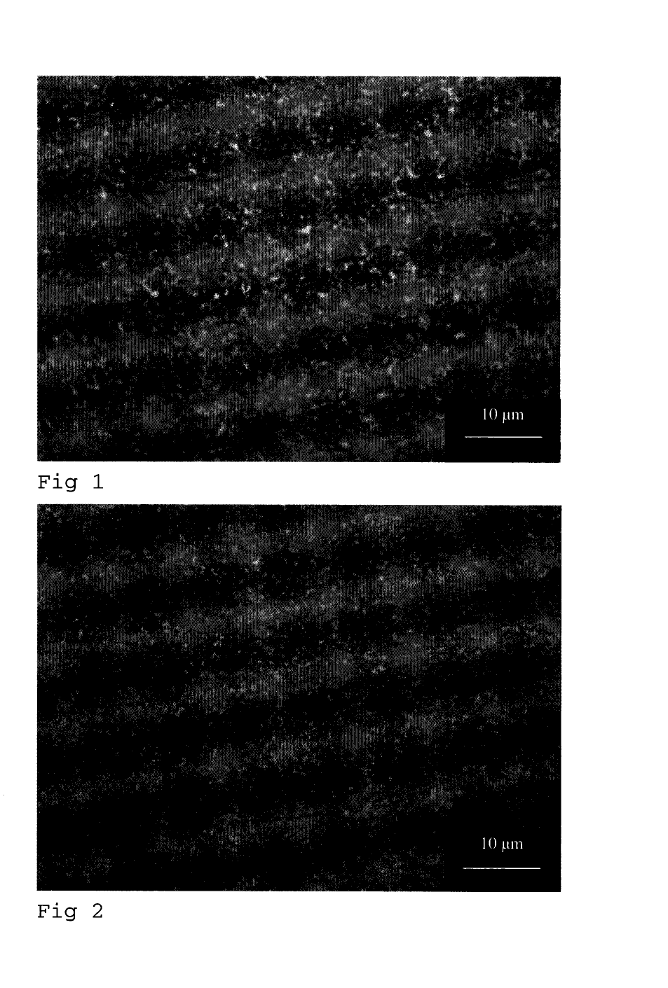

FIG. 1 shows a LOM micrograph with a magnification of about 1000× of the microstructure of a cemented carbide according to prior art.

FIG. 2 shows a LOM micrograph with a magnification of about 1000× of the microstructure of a cemented carbide according to the invention.

It has now surprisingly been found that by heating up the cemented carbide powder mixture in the mixer and by adding the organic binders in melted form, making sure that the temperature does not fall below the melting temperatures of the organic binders, no organic binder particles are formed and the abovementioned problems can be solved.

The method according to the present invention comprises the following steps:

1) Wet milling of the raw materials in water or alcohol, or a combination thereof, preferably 80 wt-% ethanol and 20 wt-% water, together with 0.1-1.2 wt-%, preferably 0.25-0.55 wt-% carboxylic acid, preferably stearic acid as a granulating agent for the subsequent drying. More carboxylic acid is required the smaller the grain size of the hard constituents.

2) Drying of the slurry formed during the above mentioned wet milling process step.

3) Mixing the dried powder by kneading with a organic binders, comprising 30-60 wt-% olefinic polymers, 40-70 wt-% waxes and to a solids loading of φ=0.52-0.58, preferably 0.54-0.56. The mixing is performed in a batch mixer or a screw extruder preferably a twin screw extruder. When using a batch mixer, the cemented carbide powder mixture is added first to the heated mixer. When the temperature of the powder mixture in the mixer is above the melting point of the organic binders, the organic binders are slowly added to the mixer in melted form, making sure that the temperature of the powder mixture and organic binders does not fall below the melting temperatures of the organic binders, preferably between 95 and 180° C. When a twin screw extruder is used for the mixing, the organic binders are added in the beginning of the screw and the powdered hard constituents are added by side feeders, making sure the powders are mixed into a melt and also making sure that the temperature does not fall below the melting temperature of the organic binders. The powdered constituents can be added through several side feeders along the twin screw extruder or the material can be run through the twin screw extruder several times to make sure the temperature does not fall below the melting temperature of the organic binders. Alternatively, the powdered hard constituents are preheated before being added to the molten organic binder to make sure that the temperature does not fall below the melting temperature of the organic binders. The material is then formed into pellets with a size of about 4×4 mm.

4) Injection moulding of the feedstock in a conventional injection moulding machine. Alternatively, the feedstock is extruded in a single screw, twin screw or plunge type extruder. The material is heated to 100-240° C., preferably 110-130° C., and then, in the case of injection moulding, forced into a cavity with the desired shape. In extrusion, the material is forced through a die with the desired cross section. The part obtained in injection moulding is cooled and then removed from the cavity. The extrudates are cut in pieces of desired length.

5) Debinding the obtained part. The debinding is performed in two steps.

5a) By extraction of the wax and petroleum jelly in an apolar solvent, at 31-80° C., preferably at 50-65° C. It is within the purview of the skilled artisan to determine by experiments the conditions necessary to avoid the formation of cracks and other defects according to this specification.

5b) By heating in a furnace, preferably in a flowing gaseous medium atmosphere, at 2 mbar to atmospheric pressure up to 450° C. It is within the purview of the skilled artisan to determine by experiments the conditions necessary to avoid the formation of cracks and other defects according to this specification.

6) Presintering of the part in the debinding furnace in vacuum at 900-1250° C., preferably at about 1200° C.

7) Sintering of the parts using conventional sintering technique.

The invention can be used for all compositions of cemented carbide and all WC grain sizes commonly used. It is obvious that it also can be used for titanium carbonitride based materials.

In one embodiment the WC grain size shall be 0.2-1.5 μm with conventional grain growth inhibitors. In another embodiment the WC grain size shall be 1.5-4 μm.

The invention also relates to cemented carbide based hard metal parts comprising hard constituents in a binder phase.

The parts have a porosity of A00 B00 C00 according to ISO 4505, an even binder phase distribution with an average binder phase lake size of 0.2-0.5 μm.

EXAMPLE 1

A WC-13 wt-% Co submicron cemented carbide powder was made by wet milling 780 g Co-powder (OMG extra fine), 38.66 g Cr₃C₂ (H C Starck), 5161 g WC (H C Starck DS80), 20.44 g W metal powder, 16 g Fisher-Tropsch wax (Sasol Hl) and 22 g stearic acid in 1.6 l milling liquid consisting of ethanol and water (80:20 by weight) for 40 h. The stearic acid is added in this stage of the process to work as a granule forming agent, when spray drying the slurry. The resulting slurry was spraydried to a granulated powder.

### EXAMPLE 2 (COMPARATIVE)

The powder made in Example 1 was mixed by kneading 2500 g powder from Example 1 with 50.97 g poly(ethylene-co-(alpha-octene)) with a DSC melting point at 93° C. according to Dow Method (Engage 8440, Dow Plastics) and 45.87 g Paraffin wax with a melting point at 58-60° C. (Sasol Wax 5805) and 5.06 g petroleum jelly with a melting point in between 45 and 60° C. (Merkur VARA AB) in a Z-blade kneader mixer (Werner & Pfleiderer LUK 1,0). The Z-blade kneader was heated to 150° C. and the raw material was added. The mixer was run until a smooth viscous feedstock developed. This resulted in a feedstock with a density of 8.23 g/ml, corresponding to a 0 of 0.553.

### EXAMPLE 3 (INVENTION)

The powder made in Example 1 was mixed by kneading 2500 g powder from Example 1 with 50.97 g poly(ethylene-co-(alpha-octene)) with a DSC melting point at 93° C. according to Dow Method (Engage 8440, Dow Plastics) and 45.87 g Paraffin wax with a melting point at 58-60° C. (Sasol Wax) and 5.06 g petroleum jelly with a melting point in between 45 and 60° C. (Merkur VARA AB) in a Z-blade kneader mixer (Werner & Pfleiderer LUK 1,0). The Z-blade kneader was heated to 150° C. and the powdered hard constituents were added first to the mixer. When the temperature of the powdered hard constituents was above the melting temperature of the organic binders the organic binders was slowly added in melted form to the mixer, making sure the temperature did not fall below the melting temperatures of the organic binders. The mixer was run until a smooth viscous feedstock developed. This resulted in a feedstock with a density of 8.23 g/ml, corresponding to a φ of 0.553.

### EXAMPLE 4 (COMPARATIVE)

The feedstock made in example 2 was fed into an injection moulding machine (Battenfeld HM 60/130/22). The machine was used for the injection moulding of a Seco Tools Minimaster 10 mm endmill green body.

### EXAMPLE 5 (INVENTION)

The feedstock made in example 3 was fed into an injection moulding machine (Battenfeld HM 60/130/22). The machine was used for the injection moulding of a Seco Tools Minimaster 10 mm endmill green body.

### EXAMPLE 6 (COMPARATIVE)

The parts from example 4 were debound by extraction and sintered in a Sinter-HIP furnace (PVA COD733R) at 1420° C. with a total soaking time of 60 min. After 30 min at the peak hold temperature, the furnace pressure was raised to 3 MPa Ar.

After sintering, the parts were cut for inspection. The parts from example 4 were free from carbon pores, eta-phase and pores, i.e. A00 B00 C00 according to ISO 4505. The parts showed Co-lakes and open surface pores. The average Co-lake size is about 0.5-1.0 μm. See FIG. 1.

### EXAMPLE 7 (INVENTION)

The parts from example 5 were debound by extraction and sintered in a Sinter-HIP furnace (PVA COD733R) at 1420° C. with a total soaking time of 60 min. After 30 min at the peak hold temperature, the furnace pressure was raised to 3 MPa Ar.

After sintering, the parts were cut for inspection. The parts from example 5 were free from carbon pores, cracks, eta-phase and pores, i.e. A00 B00 C00 according to ISO 4505. There were no surface pores and the microstructure showed an even Cobalt distribution. The average Co-lake size is about 0.2-0.5 μm. See FIG. 2.

1. A method for the production of cemented carbide based hard metal parts comprising hard constituents in a binder phase by using powder injection moulding or extrusion of a mixture of hard constituents and binder phase in organic binders having a melting point, the method comprising the steps of:
mixing powders of the hard constituents and binder phase to form a mixture;
heating the mixture of hard constituents and binder phase to a temperature;
when the temperature of the mixture of hard constituents and binder phase is above the melting point of the organic binders, adding the organic binders in melted form, such that the temperature does not fall below the melting point of the organic binders;
forming the parts by powder injection moulding or extrusion;
removing the organic binders from the obtained parts by a debinding step; and
sintering the parts.

2. The method according to claim 1, further comprising the step of holding the temperature of the mixture hard constituents and binder phase between 95 and 180° C.

3. The method according to claim 1, wherein mixing occurs in a batch mixer.

4. The method according to claim 1, wherein the mixing occurs in an extruder.

5. The method according to claim 4, wherein the extruder is a twin screw extruder.

6. The method of claim 1, wherein the carbide based hard metal parts have an even binder phase distribution with an average binder phase lake size of 0.2-0.5 μm.
